(19) United States
(12) Patent Application Publication
(10) Pub. No.: US 2009/0120547 A1
(43) Pub. Date: May 14, 2009

(54) TIRE FOR AUTOMOTIVE TOY CAR

(76) Inventor: Hai-Ching Shih, Taipei (TW)

Correspondence Address: Hai-Ching Shih, 235 Chung - Ho Box 8-24 Taipei, Taiwan, R. O. C., Taipei, 235, TW

(21) Appl. No.: 12/353,979

(22) Filed: Jan. 15, 2009

Related U.S. Application Data
(63) Continuation-in-part of application No. 11/675,075, filed on Feb. 14, 2007.

(51) Int. Cl. B60C 19/00

(52) U.S. Cl. 152/165

(57) ABSTRACT

A tire for an automotive toy car, comprises a tire body; a fiber cloth adhered with a layer of rubbers. The fiber cloth is embedded into an interior of the tire body so as to form as an annular fiber cloth; the periphery of the fiber cloth is adhered with rubber which are formed as an enclosure enclosing the fiber cloth and having four sides. A long side and two short sides are embedded into the interior of the tire body; another long side faces to an annular opening of the tire body. Each of two inner ends of the fiber cloth is embedded with a metal wire so as to increase the structure strength. The fiber cloth is one of nylon fiber, carbon fiber, fiber material, non-woven cloth, and other anti-tension materials.

The present invention is a continuation in part (CIP) of the U.S. patent application Ser. No. 11/675,075 which is assigned and invented by the applicant of the present invention. Thus, the content of the invention is incorporated into the present invention as a part of the present invention.

### BACKGROUND

The present invention relates to a tire of automotive toy cars, and more particularly to a tire having a high capacity of griping the ground and anti-tension, which improves the stability and the automotive efficiency thereof at the start moment.

Generally, the tire of toy car can be divided into two types: the rigid tire made of elasto-plastic material and the soft tire made of rubber material. The rigid tire is not easy to distort, but has a smaller friction coefficient, then the force to grip the ground of this type of the tires is not strong enough, which is liable to skid. Therefore, the rigid tire is mainly applied to the toy cars without automotive power or with lower automotive power. On the other hand, the soft tire is mainly applied to the high-level automotive toy cars because of the capability of strongly griping the ground and providing enough buffers to avoid shaking.

Nowadays, the automotive toy car use an engine or a motor as a power source, its acceleration at the start moment is very high. As shown in FIGS. 1 and 2, the typical tire includes a tire rim 20 and a tire body 10 nested on the tire rim 20, and the tire has a speed higher than that of a general car in the period of forepart accelerate. However, the tire body 10 is made of soft rubber material, which has a bad anti-tension capability. Then the tire body 10 is elongated to an oval shape (as shown in FIG. 1), and the width of the tire body 10 is becoming narrow (as shown in FIG. 2, from a side view). The pattern of the tire body 10 is distorted, which will significantly impact the motive of the toy car. Moreover, the toy car is liable to turn over because of distorting or skidding of the tire body 10. That is, the stability and the automotive efficiency of this toy car at the start moment are significantly impacted.

Accordingly, what is needed is a tire of an automotive toy car that can overcome the above-described deficiencies.

### SUMMARY OF THE INVENTION

A tire of an automotive car is not easy to be distorted, which can improve the stability and the automotive efficiency of this toy car at the start moment.

A tire for an automotive toy car comprises a tire body; a fiber cloth adhered with a layer of rubbers. The fiber cloth is embedded into an interior of the tire body so as to form as an annular fiber cloth; the periphery of the fiber cloth is adhered with rubber which are formed as an enclosure enclosing the fiber cloth and having four sides. A long side and two short sides are embedded into the interior of the tire body; another long side faces to an annular opening of the tire body. Each of two inner ends of the fiber cloth is embedded with a metal wire so as to increase the structure strength. The fiber cloth is one of nylon fiber, carbon fiber, fiber material, non-woven cloth, and other anti-tension materials.

With these configurations, the anti-tension capability of the tire body is improved, which is not liable to distort in the period of forepart accelerate. Then the toy car is prevented from turning over for the reason of distorting of the tire body. In addition, the stability and the automotive efficiency of the toy car at the start moment are also improved.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view showing a part of a tire body with the fiber cloth therein according to the present invention.

FIG. 2 is a cross sectional view showing the fiber cloth with a rubber outer layer according to the present invention.

FIG. 3 is another schematic view showing a part of a tire body with the fiber cloth therein according to the present invention.

FIG. 4 is a further schematic view showing a part of a tire body with the fiber cloth therein according to the present invention.

### DETAILED DESCRIPTION

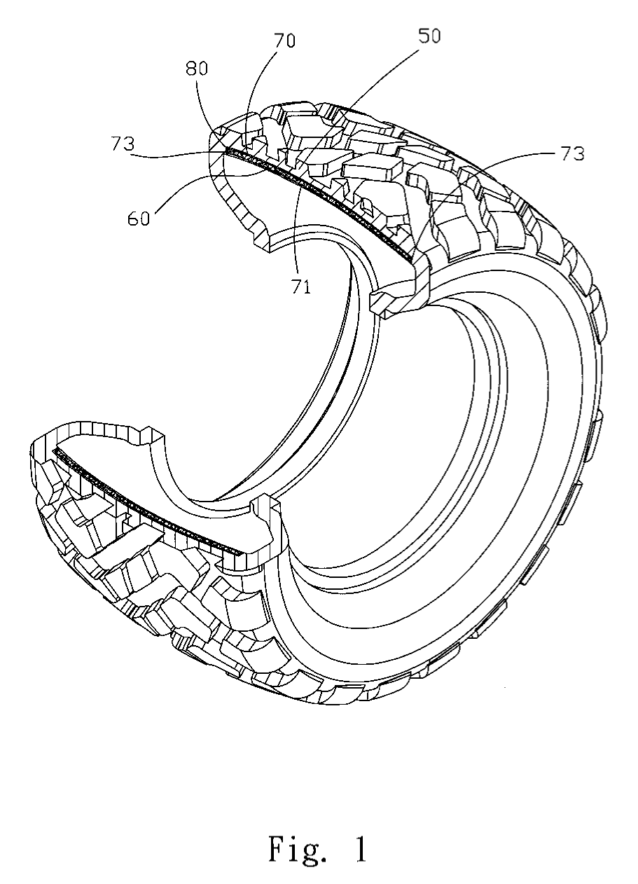

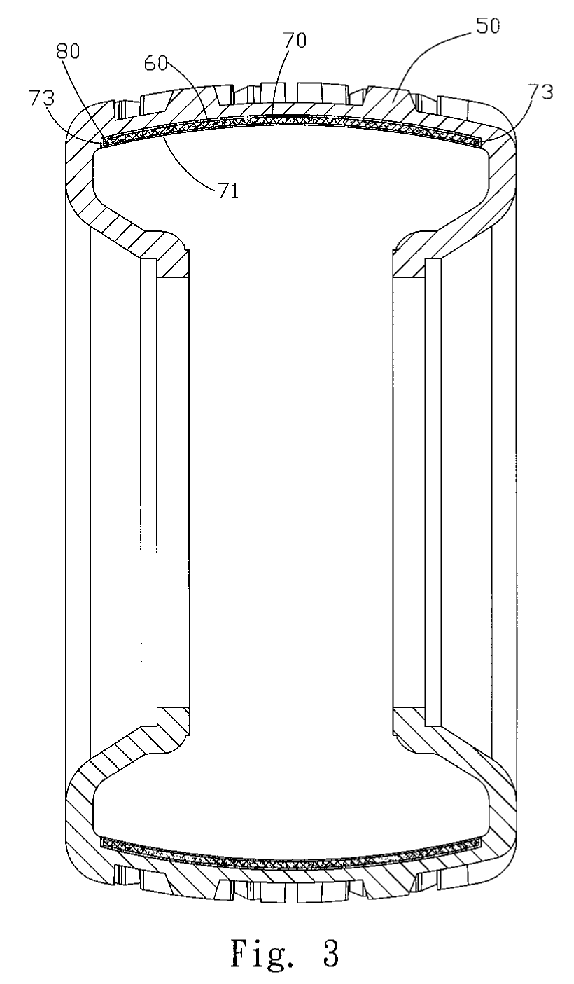

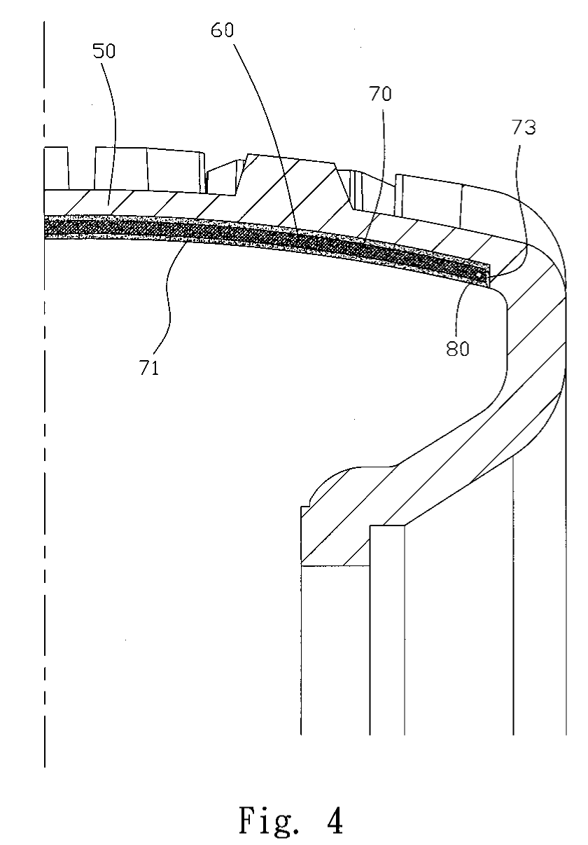

Referring to FIGS. 1 to 4, the structure of the present invention is illustrated. The tire includes a tire rim (not shown) and a tire body 50 nested on the tire rim, and the tire body 50 is made of rubber material via a molding process, which has a preferable friction to improve a force of griping the ground.

During the process of fabricating the tire body 50, firstly a fiber cloth 60 is sunk into rubber liquid so that a periphery of the fiber cloth 60 is adhered with the rubber liquid. Then the fiber cloth 60 with the rubber liquid at the periphery thereof is placed into a mold for making the tire body 50. At the same time, the mold also filled with rubber liquid for forming the tire body. The rubber liquid in the mold for forming the tire body is identical to the rubber liquid adhered to the periphery of the fiber cloth. Finally the tire is cast from the mold so as to form with a tire body 50 having the fiber cloth 60 as illustrated in FIG. 1 of the present invention. The rubber material completely surround the fiber cloth 50. Finally, cooling the rubber material to get a tire body 50 having a pre-determined shape.

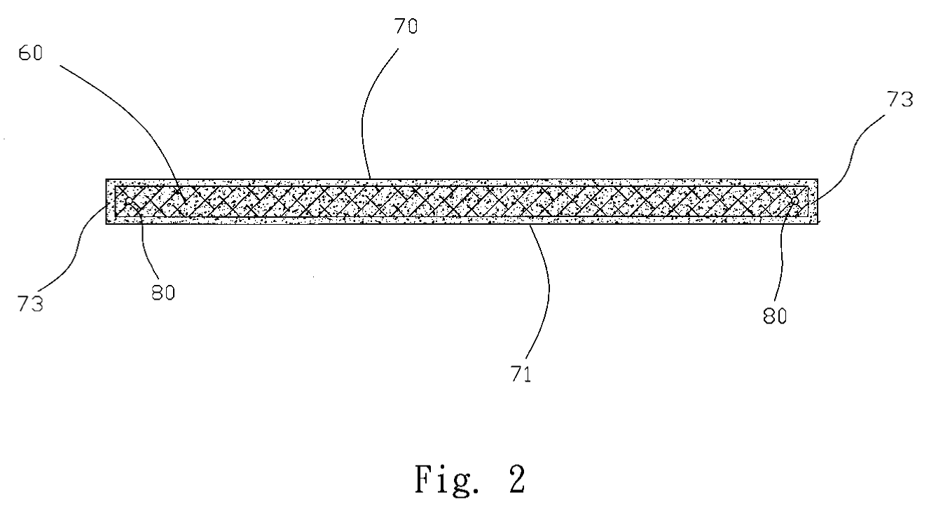

With reference to FIG. 2, it is illustrated that a periphery of the fiber cloth 50 is adhered with a layer of rubbers 70, 71, and 73. Referring to FIGS. 1 and 2, it illustrates that fiber cloth 50 is embedded into an interior of the tire body 50 so as to form as an annular fiber cloth 50. The periphery of the fiber cloth 50 is adhered with rubber which are formed as an enclosure having four sides 70, 71, 71, and 73 (referring to FIG. 2). A long side 70 and two short sides 73, 73 are embedded into an interior of the tire body 50. Another long side 71 faces to an annular opening of the tire body 50. Furthermore, the long side 71 is flushed with the inner surfaces of the tire body 50 so as to retain a flat surface in the interior of the tire body 50. Therefore, when the tire rotates with a very high speed, the tire fiber cloth 50 still retains in the tire body 50 without falling out.

Preferably, as illustrated in FIG. 2, each of two inner ends of the fiber cloth 50 is embedded with a metal wire 80 so as to increase the structure strength.

In the present invention, the fiber cloth 50 can be one of nylon fiber, carbon fiber, fiber material, non-woven cloth, or other anti-tension materials. In this illustrated embodiment, the fiber cloth 50 with the rubber layer at the periphery thereof serves to improve the joint intensity between the tire body 50.

The tire body 50 with the fiber cloth 50 therein has a preferable anti-tension capability. Furthermore, for the reason of being made of rubber material, the tire body 50 can maintain the friction between the pattern thereof and the ground and the force of griping the ground. In addition, the fiber cloth 50 prevent the tire body from being distorted when the toy car equipping the tire body at the start moment or in the period of accelerating. The tire body 50 maintains the Figure can prevent the toy car from turning over or jumping, so as to improve the stability and the automotive efficiency of this toy car. The tire body 50 is made of soft material, then it can provide buffer and avoid shaking of the toy car.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

1. A tire for an automotive toy car, comprising
a tire body;
a fiber cloth adhered with a layer of rubbers;
wherein the fiber cloth is embedded into an interior of the tire body so as to form as an annular fiber cloth; the periphery of the fiber cloth is adhered with rubber which are formed as an enclosure enclosing the fiber cloth and having four sides; a long side and two short sides are embedded into the interior of the tire body; another long side faces to an annular opening of the tire body.

2. The tire for an automotive toy car as claimed in claim 1, wherein each of two inner ends of the fiber cloth is embedded with a metal wire so as to increase the structure strength.

3. The tire for an automotive toy car as claimed in claim 1, wherein the fiber cloth is one of nylon fiber, carbon fiber, fiber material, non-woven cloth, and other anti-tension materials.

4. The tire for an automotive toy car as claimed in claim 1, wherein during the process of fabricating the tire body, firstly a fiber cloth is sunk into rubber liquid so that a periphery of the fiber cloth is adhered with the rubber liquid; then the fiber cloth with the rubber liquid at the periphery thereof is placed into a mold for making the tire body; the mold is also filled with rubber liquid for forming the tire body; the rubber liquid in the mold for forming the tire body is identical to the rubber liquid adhered to the periphery of the fiber cloth; finally the tire is cast from the mold so as to form with a tire body having the fiber cloth; finally, the rubber material is cooled to get a tire body having a pre-determined shape.

5. The tire for an automotive toy car as claimed in claim 1, wherein the long side facing to the annular opening of the tire body is flushed with the inner surfaces of the tire body so as to retain a flat surface in the interior of the tire body.
